(19) United States
(12) Patent Application Publication
(10) Pub. No.: US 2005/0007922 A1
(43) Pub. Date: Jan. 13, 2005

(54) Optical disc drive

(75) Inventor: Masanori Ujino, Osaka (JP)

Correspondence Address: MORGAN LEWIS & BOCKIUS LLP, 1111 PENNSYLVANIA AVENUE NW, WASHINGTON, DC, 20004, US

(73) Assignee: FUNAI ELECTRIC CO., LTD.

(21) Appl. No.: 10/843,573

(22) Filed: May 12, 2004

(30) Foreign Application Priority Data
May 13, 2003 (JP) P 2003-134141

(51) Int. Cl. G11B 5/09

(52) U.S. Cl. 369/53.2; 369/59.23

(57) ABSTRACT

The optical disc drive acquires the copy restriction information concerning copy restriction of data recorded on the optical disc by way of wireless communications with the wireless tag attached to the optical disc inserted in the optical disc drive. Determining that data copy is prohibited based on the acquired copy restriction information, the optical disc drive includes a code-indicating copy prohibition in the data acquired from the optical disc and outputs the resulting data.

### BACKGROUND OF THE INVENTION

1. Field of the Invention

The present invention relates to an optical disc drive which reads data recorded on an optical disc such as a CD and a DVD and records data onto an optical disc.

2. Description of the Related Art

In the related art, JP-A-2002-163613 and JP-A-2002-288963 propose that a wireless tag having a wireless communication feature be attached to (embedded into) an optical disc so as to allow the user to readily check the contents of recording on an optical disc such as a CD and a DVD. To be more specific, contents of recording on the optical disc are stored into a nonvolatile memory in the wireless tag attached to the optical disc and the contents of recording on the optical disc can be checked by way of wireless communications with the wireless tag. The user can check the contents of recording on the optical disc without playing the optical disc and readily locate the desired optical disc (to be played).

However, use of information stored in the wireless tag attached to the optical disc in the processing to read or store data from/onto an optical disc inserted in an optical disc drive by the same has not been proposed.

Especially in recent years, illegal copy of data recorded on an optical disc presents a serious problem and development of a technology to prevent illegal data copy is in growing demand.

### SUMMARY OF THE INVENTION

An object of the invention is to provide an optical disc drive which uses the information stored on a wireless tag attached to an optical disc to control the operation of reading or recording data from/onto the optical disc.

Another object of the invention is to provide an optical disc drive which uses the information stored on a wireless tag attached to an optical disc to prevent illegal copy of data recorded onto the optical disc.

Another object of the invention is to provide an optical disc drive which uses the information stored on a wireless tag attached to an optical disc to control the operation of reading or recording data from/onto the optical disc so as to smooth the operation.

In order to attain the objects, the invention provides an optical disc drive mentioned below.

A first aspect of the invention provides an optical disc drive including readout section which reads data recorded on an optical disc inserted in the optical disc drive, the optical disc drive further including: a wireless communication section which, when a wireless tag storing copy restriction information concerning copy restriction of the data recorded on an optical disc inserted in the optical disc drive is attached to the optical disc, acquires the copy restriction information stored in the wireless tag by way of wireless communications with the wireless tag; a copy permission/prohibition determination section which determines whether copy of the data recorded on an optical disc is permitted based on the copy restriction information acquired by the wireless communication section; and a read data output section which, in case the copy permission/prohibition determination section has determined that copy is prohibited, includes a code indicating copy prohibition in the data read from the optical disc and outputs the resulting data.

In the first aspect of the invention, copy restriction information concerning copy restriction of data stored on the optical disc is stored in the wireless tag attached to the optical disc. The copy restriction information is information indicating for example copy prohibition, copy permission and copy permission period (or copy prohibition period). The wireless communication section acquires the copy restriction information by way of wireless communications with the wireless tag attached to the optical disc inserted in the optical disc drive. The copy permission/prohibition determination section determines whether copy of the data recorded on the optical disc is permitted based on the copy restriction information acquired from the wireless tag. When the copy permission/prohibition determination section has determined that copy is prohibited, the read data output section includes a code indicating copy prohibition in the data read from the optical disc and outputs the resulting data.

It is thus possible to notify apparatus to which the data output from the read data output section that data copy is prohibited, thereby preventing illegal copy of the data onto a separate optical disc without permission.

A second aspect of the invention provides an optical disc drive including: recording section which records data onto an optical disc inserted in the optical disc drive; and a recording control section which, when recording data to be recorded onto an optical disc inserted in the optical disc drive is input, determines whether a code indicating copy prohibition is included in the recording data, and which, in case it is included, prohibits recording of the data onto the optical disc by the recording section.

In the second aspect of the invention, in case, when recording data to be recorded onto an optical disc inserted in the optical disc drive is input, the code indicating copy prohibition is included in the recording data, data recording onto an optical disc by the recording section is prohibited.

Even in case the data output by the read data output section is temporarily saved into a personal computer (PC), the optical disc inserted in the optical disc drive is swapped with another optical disc and the saved data is later input as recording data, it is possible to prevent the recording data, that is, the copy-prohibited data read from an optical disc from being copied (recorded) onto another optical disc.

A third aspect of the invention provides an optical disc drive including readout section which reads data recorded on an optical disc inserted in the optical disc drive and recording section which records data onto the optical disc, the optical disc drive further including: a wireless communication section which, when a wireless tag storing type information indicating the type of an optical disc inserted in the optical disc drive is attached to the optical disc, acquires the type information stored in the wireless tag by way of wireless communications with the wireless tag; a readout control section which controls data readout by the readout section based on the type information acquired by the wireless communication section; and a recording control section which controls data recording by the recording section based on the type information acquired by the wireless communication section.

In the third aspect of the invention, the wireless tag attached to an optical disc stores the type information indicating the type of the optical disc. The type information includes, for example, information indicating the type of optical disc (such as a CD and a DVD), information indicating the number of recording layers (single layer, double layer), and information indicating whether the optical disc is the read-only type or rewritable type. Based on the type information acquired by the wireless communication section from the wireless tag, the readout control section controls data readout from an optical disc by the readout section and the recording control section controls data recording onto the optical disc by the recording section.

It is thus possible to eliminate the need for reading the type information recorded on the optical disc in order to check the type of the optical disc inserted in the optical disc drive, thus smoothing readout of recorded data and data recording operation, thereby reducing the processing time.

A fourth aspect of the invention provides an optical disc drive including wireless communication control section which, before rotating an optical disc inserted in the optical disc drive by using a spindle motor, acquires the information stored in the wireless tag by way of the wireless communication section.

In the fourth aspect of the invention, before rotating an optical disc inserted in the optical disc drive by using a spindle motor, the wireless communication control section performs wireless communications with the wireless tag by way of wireless communication section. In other words, the wireless communication control section performs wireless communications with the wireless tag while the optical disc is not rotating. Thus wireless communications are carried out without changing the alignment of the wireless communication section with the wireless tag, thereby stabilizing the wireless communications

### BRIEF DESCRIPTION OF THE DRAWINGS

These and other objects and advantages of this invention will become more fully apparent from the following detailed description taken with the accompanying drawings in which:

FIG. 1 is a block diagram showing an optical disc drive according to an embodiment of the invention;

FIG. 2 shows an optical disc in which a tag is embedded;

FIG. 3 shows the tag configuration;

FIG. 4 is a flowchart showing the operation of the optical disc drive according to this embodiment;

FIG. 5 is a flowchart showing the readout processing of the optical disc drive according to this embodiment; and

FIG. 6 is a flowchart showing the recording processing of the optical disc drive according to this embodiment.

### DETAILED DESCRIPTION OF THE PREFERRED EMBODIMENTS

An optical disc drive according to an embodiment of the invention is described below.

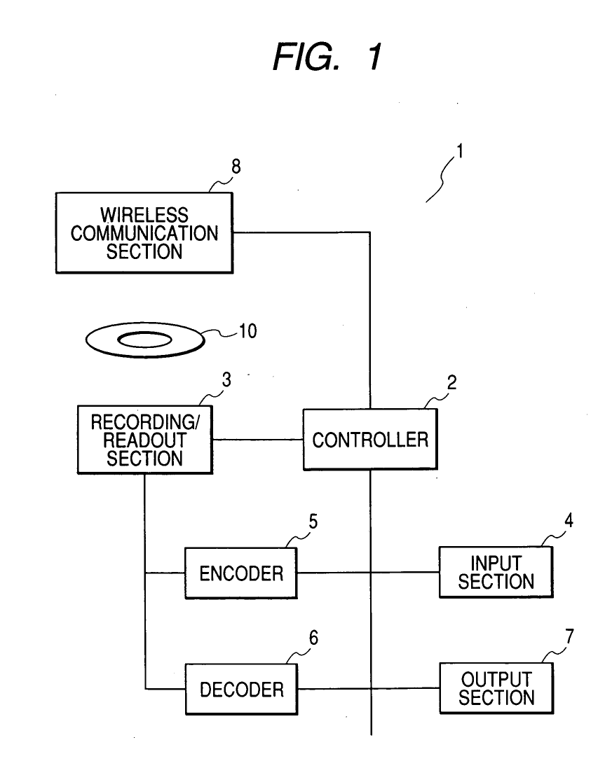

FIG. 1 is a block diagram showing an optical disc drive according to an embodiment of the invention. The optical disc drive 1 according to this embodiment includes a controller 2 which controls the operation of the optical disc drive, a recording/readout section 3 which reads data recorded on an optical disc 10 inserted in the optical disc drive and which records data onto the optical disc, an input section which accepts data input from external apparatus, am encoder 5 which encodes the data accepted by the input section 4, a decoder 6 which decodes the data read from the optical disc 10 by the recording/readout section 3, an output section 7 for outputting the data decoded by the decoder 6 to external apparatus, and a wireless communication section 8 which performs wireless communications with a wireless tag attached to)embedded in) the optical disc 10 inserted in the optical disc drive.

The recording/readout section 3 includes a spindle motor which holds and rotates the optical disc 10 such as a CD and a DVD inserted in the optical disc drive, a pickup head which irradiates laser light onto the optical disc 10 as well as detects its reflected light, a motor which moves the pickup head in the radial direction of the optical disc 10, and a laser driver which controls the power of the laser light irradiated onto the optical disc 10. The input section 4 accepts input of data transmitted from a PC. The encoder 5 encodes the data accepted by the input section 4 in a predetermined format such as MPEG2. To the input section 4 is input data to be recorded onto the optical disc 10 as well as a control signal to be directed to the controller 2 of the optical disc drive concerning start of data recording, start of readout and pause. The decoder 6 decodes the data read by the recording/readout section 3 from the optical disc 10. The output section 7 outputs the data decoded by the decoder 6 to external apparatus such as a PC.

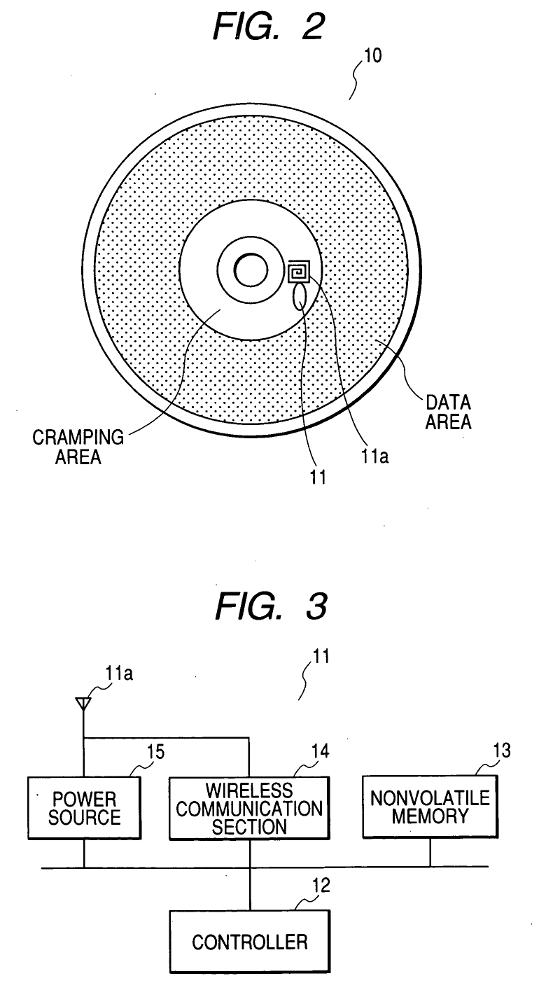

The wireless communication section 8 performs wireless communications with the wireless tag 11 attached to the optical disc 10. The wireless tag 11 is embedded in a cramping area of the optical disc 10 where data recording layers are not formed as shown in FIG. 2. The communication area of the wireless communication section 8 includes the area where the cramping area of the optical disc 10 inserted in the optical disc drive is located and is a limited area on the periphery of the cramping area. In other words, the wireless communication section 8 does not perform wireless communications with the wireless tag 11 attached to the optical disc 10 not inserted in the optical disc drive.

On the surface of the optical disc 10 is formed an antenna 11a of the wireless tag 11. FIG. 3 is a block diagram showing the configuration of the wireless tag. The wireless tag 11 includes a controller 12 which controls the operation of the optical disc drive, a nonvolatile memory 13 which stores copy restriction information concerning copy restriction of data recorded on the optical disc 10 and type information indicating the type of the optical disc 10, a wireless communication section 14 which performs wireless communications, and a power source 15 which supplies operating power to each section of the optical disc drive.

The copy restriction information stored in the nonvolatile memory 13 includes information indicating copy prohibition, copy permission and copy permission period (or copy prohibition period). The type information includes information indicating the type of optical disc (such as a CD and a DVD), information indicating the number of recording layers (single layer, double layer), and information indicating whether the optical disc is the read-only type or rewritable type. The power source 15 obtains an operating power to be supplied to each section of the optical disc drive from a carrier wave (a carrier wave output from the wireless communication section 8 of the optical disc drive 1).

The nonvolatile memory 13 may be a ROM.

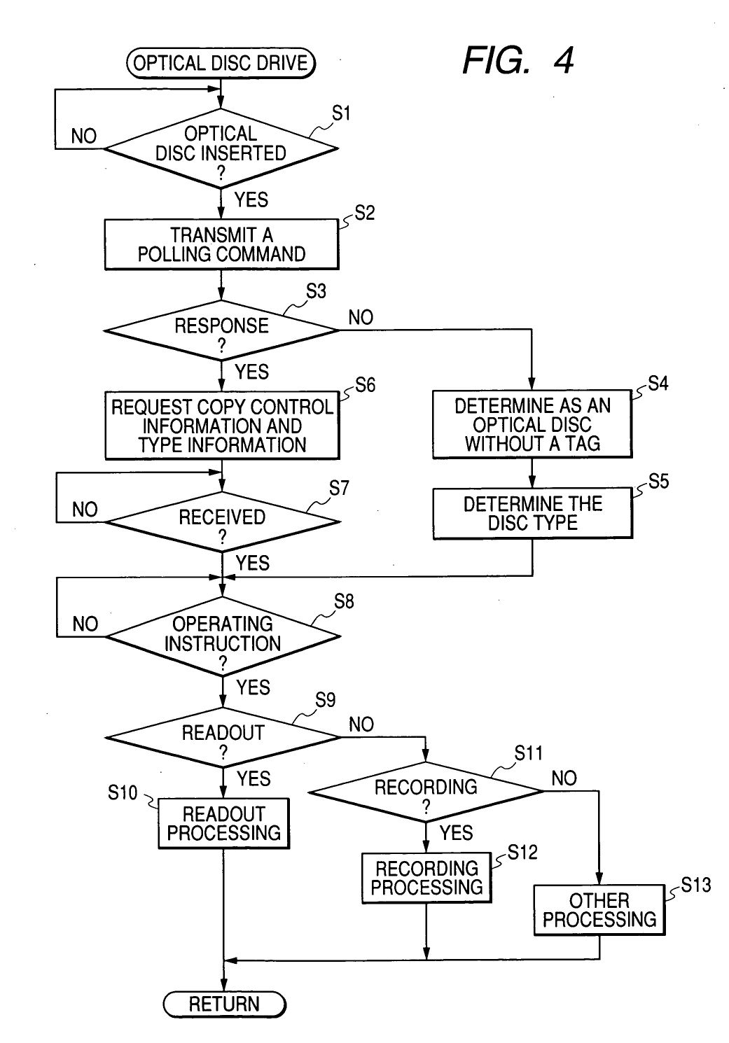

Next, operation of the optical disc drive according to the embodiment is described below. FIG. 4 is a flowchart showing the operation of the optical disc drive according to this embodiment. When the optical disc 10 is inserted in the optical disc drive 1 (s1), the optical disc drive 1 transmits a polling command for the wireless tag 11 from the wireless communication section 8 to the optical disc 10 inserted in the optical disc drive (s2). In this practice, the optical disc drive 1 is not rotating the optical disc 10 inserted in the optical disc drive by using a spindle motor. The communication section 8 of the optical disc drive 1 keeps emitting an electromagnetic wave (carrier wave) even after the polling command has been transmitted.

The optical disc drive 1, in the absence of a response to a polling command transmitted to the wireless tag 11 within a predetermined time (several seconds) in step s2, assumes that the optical disc 11 to which the wireless tag 11 is not attached is inserted in the optical disc drive (s3, s4). After that, the optical disc drive 1 stops emitting the electromagnetic wave from the communication section 8, rotates the optical disc 10 inserted in the optical disc drive, and determines the type of the optical disc 10 (such as a CD and a DVD), the number of recording layers (single layer, double layer), and whether the optical disc is the read-only type or rewritable type (s5). In s5, the optical disc drive 1 determines the type of theoptical disc by reading the type information recorded on the optical disc.

The optical disc drive 1, on receiving a response to a polling command transmitted to the wireless tag 11 within a predeterminedtime (several seconds) instep s2, issues arequest for transmission of the copy restriction information stored in the nonvolatile memory 13 and the type information to the wireless tag 11 (s6). The optical disc drive 1 waits for the copy restriction information and the type information to be transmitted from the wireless tag 11 in response to the request issued in step s6 (s7). The optical disc drive 1 obtains the information on whether copy of the data recorded on the optical disc 10 installed in the optical disc drive is permitted and the information on the type of the optical disc 10 by receiving the copy restriction information and the type information transmitted from the wireless tag 11. In other words, it is possible to obtain type of the optical disc 10 without executing the step s5. The need for disc tray opening/closing operation and retry operation is eliminated so that data readout and data recording are smoothed.

Wireless communications with the wireless tag 11 is performed while the optical disc inserted in the optical disc drive is not rotated by a spindle motor. This does not change the alignment of the wireless communication section with the wireless tag, thereby stabilizing the wireless communications. The power required for disc rotation and power required for illuminating a laser light for determining the type information of the disc are not required.

The optical disc drive 1, on receiving copy restriction information and type information transmitted from the wireless tag 11 in step s7, stops emission of an electromagnetic wave from the communication section 8. As mentioned above, the wireless communication area of the communication section 8 is a limited area where the cramping area of the optical disc 10 inserted in the optical disc drive is located. Thus, the wireless communication section 8 does not perform wireless communications with the wireless tag 11 attached to the optical disc 10 not inserted in the optical disc drive.

The optical disc drive 1, on competing the processing on step s5 or s7, waits for an operation instruction to be input to the optical disc drive (s8). The operating instruction includes an instruction to read data from the optical disc 10 inserted in the optical disc drive, an instruction to record data onto the optical disc 10, and an instruction to remove the optical disc 10. In case the current operating instruction to the optical disc drive is readout of data from the optical disc 10, the optical disc drive 1 performs data readout (s9, slO). In case the current operating instruction is recording of data onto the optical disc 10, the optical disc drive 1 performs data recording (s11, s12).

In case the current operating instruction is neither readout of data from the optical disc 10 nor data recording of data the optical disc 10, the optical disc drive 1 performs the processing according to the current operating instruction (other processing) (s13).

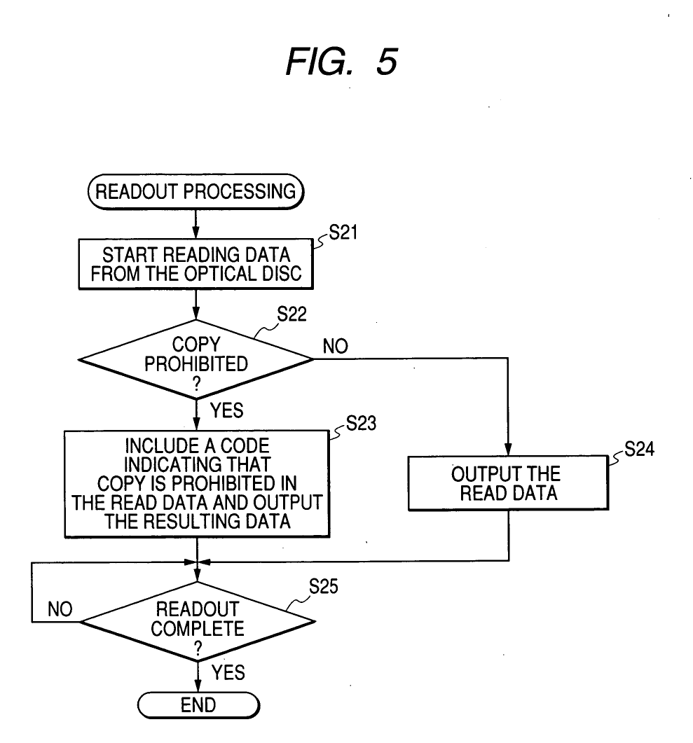

Readout processing in s10 is described below. FIG. 5 is a flowchart showing this readout processing. The optical disc drive 1 starts, on the recording/readout section 3, starts reading the data recorded on the optical disc 10 inserted in the optical disc drive (s21). In step s21, the optical disc drive 1 controls data readout from the optical disc 10 based on the type determined from the type information transmitted from the wireless tag 11 attached to the optical disc 10 in step s7 or the type determined in step S5. The optical disc drive 1 also determines whether copy of the data recorded on the optical disc 10 is permitted (s22). The determination in steps 22 is based on the copy restriction information transmitted from the wireless tag 11 attached to the optical disc 10.

The optical disc drive 1, determining that data copy is permitted in step s22, decodes the data read by the recording/readout section 3 from the optical disc 10 by way of the decoder 6, and outputs the data decoded by the decoder as read data from the output section 7 (s24). The optical disc drive 1, determining that data copy is prohibited in step s22, decodes the data read by the recording/readout section 3 from the optical disc 10 by way of the decoder 6, and includes a code indicating copy prohibition in the decoded data and outputs the resulting data from the output section 7 (s23). On completing data readout from the optical disc 10 (s25), the optical disc drive 1 terminates the processing. When the processing is terminated, rotation of the optical disc 10 by the spindle motor is stopped and irradiation of laser light onto the optical disc 10 is ceased.

In this way, in case copy of data recorded on the optical disc 10 inserted in the optical disc drive is prohibited, a code indicating that data copy is prohibited is output in the data read from the optical disc 10. It is thus possible to notify the apparatus to which the data is input that the data copy is prohibited. This prevents illegal copy of the data onto a separate optical disc without permission. The type information on the optical disc 10 is acquired byway of wireless communications. So that it is not necessary to read the type information recorded on an optical disc inserted in the optical disc drive in order to check the type of the optical disc. This smoothes the arrangement concerning readout of recorded data thereby reducing the processing time.

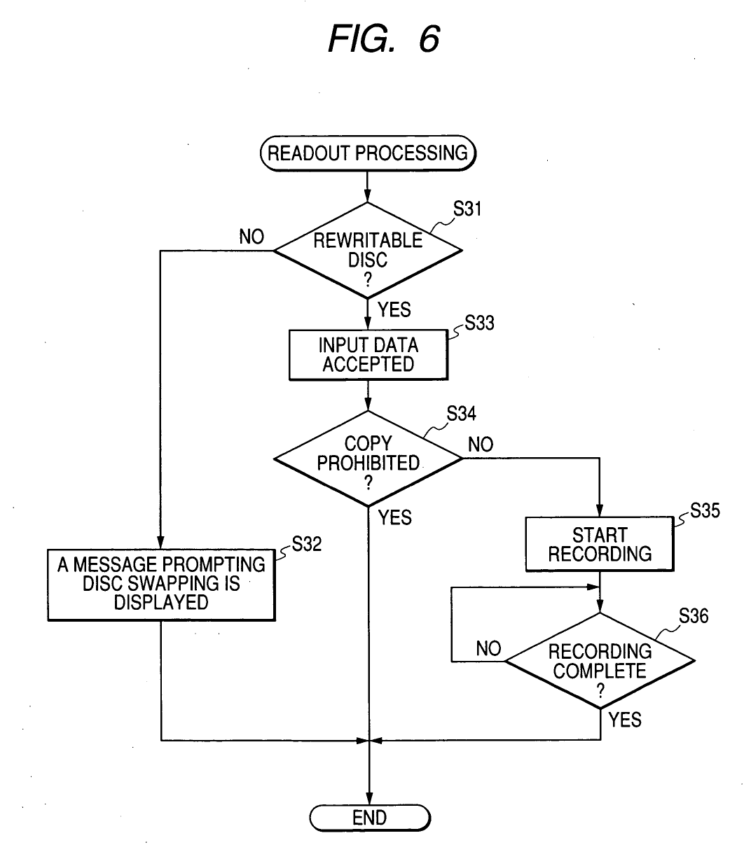

Recording processing in step s12 is described below. FIG. 6 is a flowchart showing the recording processing. The optical disc drive 1 determines whether the optical disc 10 inserted in the optical disc drive is a rewritable optical disc (s31). Processing in step s31 is performed based on the type determined from the type information transmitted from the wireless tag 11 attached to the optical disc 10 in step s7 or the type determined in step S5. Determining that the optical disc is not a rewritable optical disc in step s31, the optical disc drive 1 displays a message prompting disc swapping on a display section (not shown) in step s32 and terminates the processing.

Determining that the optical disc is a rewritable optical disc in step s31, the optical disc drive 1 accepts, on the input section 4, the input of data to be recorded onto the optical disc 10 (s33). The optical disc drive 1 determines whether a code indicating copy prohibition is included in the data input to the input section 4 (s24). In case it is included, the optical disc drive 1 terminates the processing without recording the current input data to the optical disc 10.

Determining that the code is not included in step s34, the optical disc drive 1 starts recording of data input this time (s35). In step S35, recording of data onto the optical disc 10 is controlled based on the type determined from the type information transmitted from the wireless tag 11 attached to the optical disc 10 in step s7 or the type determined in step S5. The data input to the input section 4 is encoded in a predetermined format by the encoder 5 and recorded onto the optical disc 10. The optical disc drive 1, on completing data recording onto the optical disc 10 (s36), terminates the processing. When the processing is terminated, rotation of the optical disc 10 by the spindle motor is stopped and irradiation of laser light onto the optical disc 10 is ceased.

In this way, in case a code indicating that data copy is prohibited is included in the data input to the optical disc drive to be recorded onto the optical disc 10, the optical disc drive 1 does not record the data onto the optical disc 10. In other words, the copy-prohibited data is not recorded onto the optical disc 10 thus preventing illegal copy attempts. The type information on the optical disc 10 is acquired by way of wireless communications. So that it is not necessary to read the type information recorded on an optical disc inserted in the optical disc drive in order to check the type of the optical disc. This smoothes the arrangement concerning readout of recorded data thereby reducing the processing time.

The foregoing description does not cover the process of how to include a code indicating that data copy is prohibited in particular data from the viewpoint of security.

As mentioned hereinabove, according to the invention, by way of wireless communications with a wireless tag attached to an optical disc, it is possible to acquire the copy restriction information concerning copy restriction of data recorded on the optical disc and type information indicating the type of the optical disc. This enhances the security of data recorded on the optical disc and smoothes data readout from an optical disc as well as the operation concerning recording of data onto the optical disc, thereby reducing the processing time.

1. An optical disc drive comprising:
a readout section which reads data recorded on an optical disc inserted in the optical disc drive;
a recording section which records data onto the optical disc;
a wireless communication section which, when a wireless tag storing copy restriction information concerning copy restriction of the data recorded on an optical disc inserted in the optical disc drive and type information indicating the type of the optical disc is attached to the optical disc, acquires the copy restriction information and the type information stored in the wireless tag by way of wireless communications with the wireless tag;
a copy permission/prohibition determination section which determines whether copy of the data recorded on an optical disc is permitted based on the copy restriction information acquired by the wireless communication section;
a read data output section which, in case the copy permission/prohibition determination section has determined that copy is prohibited, includes a code indicating copy prohibition in the data read from the optical disc and outputs the resulting data;
a readout control section which controls data readout by the readout section based on the type information acquired by the wireless communication section;
a recording control section which, when recording data to be recorded onto an optical disc inserted in the optical disc drive is input, determines whether a code indicating copy prohibition is included in the recording data, and which, in case it is included, prohibits recording of the data onto the optical disc by the recording section; and
a wireless communication control section which, before rotating an optical disc inserted in the optical disc drive by using a spindle motor, acquires the information stored in the wireless tag by way of the wireless communication section.

2. An optical disc drive comprising:
a readout section which reads data recorded on an optical disc inserted in the optical disc drive;
a wireless communication section which, when a wireless tag storing copy restriction information concerning copy restriction of the data recorded on an optical disc inserted in the optical disc drive is attached to the optical disc, acquires the copy restriction information stored in the wireless tag by way of wireless communications with the wireless tag;
a copy permission/prohibition determination section which determines whether copy of the data recorded on an optical disc is permitted based on the copy restriction information acquired by the wireless communication section; and
a read data output section which, in case the copy permission/prohibition determination section has determined that copy is prohibited, includes a code indicating copy prohibition in the data read from the optical disc and outputs the resulting data.

3. The optical disc drive according to claim 2, comprising:
a recording section which records data onto an optical disc inserted in the optical disc drive; and
a recording control section which, when recording data to be recorded onto an optical disc inserted in the optical disc drive is input, determines whether a code indicating copy prohibition is included in the recording data, and which, in case it is included, prohibits recording of the data onto the optical disc by the recording section.

4. An optical disc drive comprising:
a readout section which reads data recorded on an optical disc inserted in the optical disc drive;
a recording section which records data onto the optical disc;
a wireless communication section which, when a wireless tag storing type information indicating the type of an optical disc inserted in the optical disc drive is attached to the optical disc, acquires the type information stored in the wireless tag by way of wireless communications with the wireless tag;
a readout control section which controls data readout by the readout section based on the type information acquired by the wireless communication section; and
a recording control section which controls data recording by the recording section based on the type information acquired by the wireless communication section.

5. The optical disc drive according to claim 2, comprising:
a wireless communication control section which, before rotating an optical disc inserted in the optical disc drive by using a spindle motor, acquires the information stored in the wireless tag by way of the wireless communication section.
